(19) United States
(12) Patent Application Publication
(10) Pub. No.: US 2019/0265059 A1
(43) Pub. Date: Aug. 29, 2019

(54) System and Method for Real-time Transit Prioritization

(71) Applicants: Jonathan Warnick, Blue River, CO (US); James Long, Littleton, CO (US)

(72) Inventors: Jonathan Warnick, Blue River, CO (US); James Long, Littleton, CO (US)

(21) Appl. No.: 15/905,815

(22) Filed: Feb. 26, 2018

(51) Int. Cl. G01C 21/34; G08G 1/095; G05D 1/02; G08G 1/00; G06Q 40/00

(52) U.S. Cl. CPC G01C 21/3484; G08G 1/095; G05D 1/0291; G05D 2201/0213; G08G 1/20; G06Q 40/12; G01C 21/3415

(57) ABSTRACT

The present invention provides system and method, including computer programs encoded on non-transitory computer storage media, for dynamic creation of priority transit, wherein one transiting vehicle has priority over another transiting vehicle, or plurality of vehicles, the system comprising input from a plurality of navigation devices, and a server, or distributed computing platform, to receive from the plurality of navigation devices a periodic time series of location points, and the dynamic creation of an agreement, or Ricardian contract, for priority traffic preference between parties while in transit wherein the first, or priority requesting, party exchanges credits or tokens of value to another, or yielding, party in exchange for transit preference and priority. The method comprising receiving location points from a plurality of navigation devices, along with respective time stamps indicating the time of recordation of each of these location points; messaging the parties willing to offer credit or tokens of value for priority transit, and matching parties willing to receive credit or tokens of value for another's said priority transit, according to the location points and respective time stamps and contract disposition; and creating a dynamic agreement, or contract, to execute the transfer and exchange of credits and after passing priority is granted, and confirmed by the navigation devices, automatically executing the contract transferring credits from the priority vehicle account to the yielding vehicle account. This system provides, in essence, a dynamic ‘on-demand’ priority lane creation for any vehicle whether non-automated, automated, autonomous, or driverless, also known in the industry as autonomous levels 0-5, and includes a plurality of transit considerations including, but not limited to, wheeled, non-wheeled, seafaring or airborne vehicles or transportation systems. This system may be extended to include any queuing scenario.

### BACKGROUND OF THE INVENTION

### Field of the Invention

The present invention relates to the field of self-driving vehicles, ‘smart’ transit, mobile computing and peer-to-peer networking organizing to optimize travel when navigating traffic congestion. More particularly, the present invention is in the technical field of traffic networking or vehicle prioritization, and rewarding collaboration between people and people, machines and people, or between machines and machines. More particularly, the present invention is in the technical fields relating to networking integration with the Internet of Things (IoT) in regard to traffic congestion collaboration, creating dynamic, on-demand, or ‘HOV-like’ (High Occupancy Vehicle), priority lanes which incentivize cooperative traffic behavior in real-time in return for a credit reward or token of value exchange.

### Description of the Related Art

Any discussion of the prior art throughout the specification should in no way be considered as an admission that such prior art is widely known or forms part of common general knowledge in the field.

Meeting transportation needs is an increasing problem, particularly in congested areas. In regard to transportation, there are occasions when one transiting vehicle's urgency may take priority over another transiting vehicle, sometimes as mandated by law, and sometimes based on the ‘ability to pay’ for priority transit. In congested traffic, a method of allowing dynamic lanes wherein vehicles may flow more freely, and be less encumbered by slower or congested traffic, will ameliorate vehicle urgency and facilitate priority transit needs. Moreover, humanity is moving from non-automated to automated, autonomous, and driverless technologies wherein machine or ‘vehicle needs’ reflect underlying human needs and priorities. Currently in the industry, vehicular autonomous levels are:
Level 0: wherein the human driver operates and controls all steering, brakes, throttle, and power.
Level 1: wherein driver-assistance means that most functions are still controlled by the human driver, but a specific function (like steering or accelerating) can be done automatically by the car.
Level 2: wherein, at least one driver assistance system of “both steering and acceleration/deceleration using information about the driving environment” is automated, like cruise control and lane-centering. Here, the “driver is disengaged from physically operating the vehicle by having his or her hands off the steering wheel and foot off pedal at the same time,” according to the SAE. However, the driver must still always be ready to take control of the vehicle, as needed.
Level 3: wherein drivers are still necessary, but are able to completely shift “safety-critical functions” to the vehicle, under certain traffic or environmental conditions. Here, the driver is still present and will intervene if necessary, but is not required to monitor the situation in the same way it does for the previous levels.
Level 4: wherein “fully autonomous.” means vehicles are designed to perform all safety-critical driving functions and monitor roadway conditions for an entire trip. However, it's important to note that this is limited to the “operational design domain (ODD)” of the vehicle, meaning it does not cover every imaginable driving scenario.
Level 5: This refers to a fully-autonomous system that expects the vehicle's performance to equal that of a human driver, in every driving scenario—including extreme environments like dirt roads that are unlikely to be navigated by driverless vehicles in the near future.

There are known consensus methods that provide for traffic prioritization based on need or the ability to pay. For example, special police or emergency traffic signal prioritization, lanes dedicated by vehicle class, such as bus lanes, or lanes dedicated by passenger load HOV (High Occupancy Vehicle) lanes, toll or fee-only lanes. However, none of these methods is a dynamic prioritization consensus method amongst vehicles. Other methods are static or involve arbitrary schemes. For example, one of the limitations of existing HOV methods is an inability to dynamically ‘pay more’ to ‘get there faster’ on roads lacking HOV lanes, or another limitation may be to require a certain number of passengers or a certain type of vehicle or a certain type of vehicle propulsion system that may be in-favor with the current regulators (i.e. electric vehicles). Another drawback is the up-front cost to build HOV lanes, usually with public funds, with the implied purpose of excluding a certain lower class of transit and favoring a higher class of transit. Another of the drawbacks of existing HOV lanes is the inability to set real-time pricing which can allow for better lane utilization. Another drawback is the inability to ‘reward’ lower priority vehicles willing to move into slower lanes, or defer to vehicles with real or apparent higher priority. Another drawback is the lack of ability to create dynamic real-time agreements, or the ability to automate agreements, for example, with Ricardian contracts, whereby autonomous vehicles, or human operators, can record a document as a contract at law, and link it securely to other systems, such as accounting, for the contract as an issuance of value or token of utility from one vehicle to another vehicle in exchange for priority transit in order to arrive at a destination with minimum delay.

### SUMMARY OF THE INVENTION

Human ingenuity has expanded the toolbox of basic building blocks available to address traffic management and dynamic priority lane requests in a manner that is more efficient and more meaningful. Developments in mobile computing, GPS, communications technologies, distributed processing, networking, artificial intelligence (AI), or dynamically scalable cloud server platforms allow a plurality of previously unavailable human to human coordination, human to machine coordination, and machine to machine coordination.

The present invention ameliorates deficiencies described by providing a scalable, distributed, dynamic, real-time method and system, including computer programs encoded on non-transitory computer storage media, for expressing transit value or monetizing priority transit. In addition, this system and method may be abstracted for any general queueing and/or priority transit preference indication via any transit medium. For example, transit in ship navigation ports, transit in airline takeoff and/or landing slots at airports, even with transit of bicycles, pedestrians, and/or ‘flying cars’. The present invention also enables new transiting behaviors not possible before, improving transit efficiency and security.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

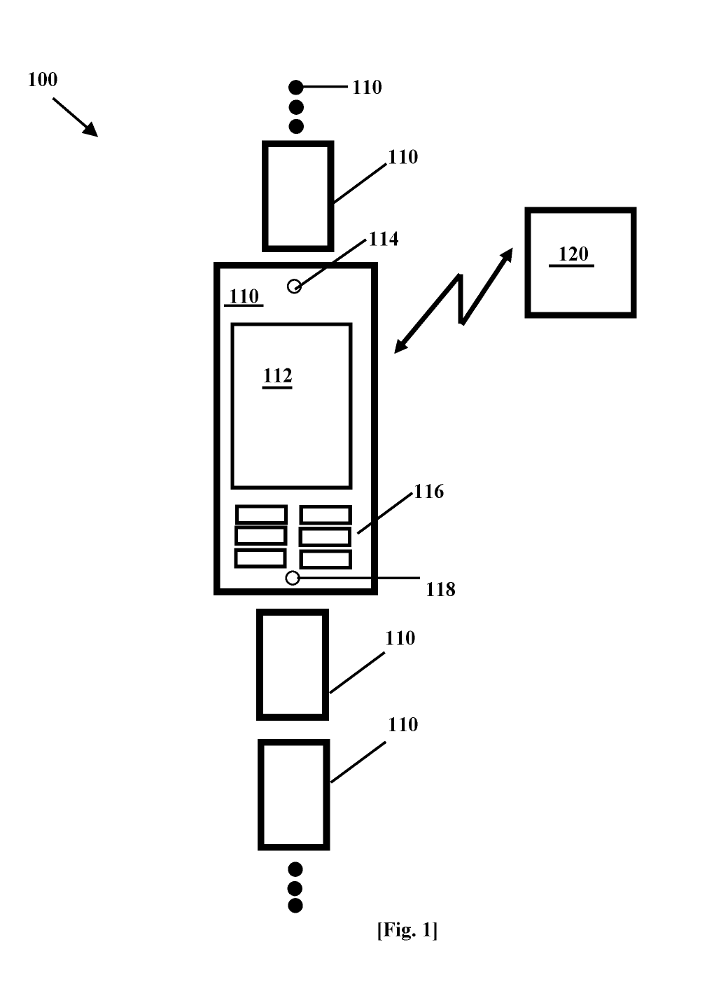

FIG. 1 is a schematic illustration of a system for organizing navigation devices to create priority transit preference mapping according to some embodiments of the present invention; and

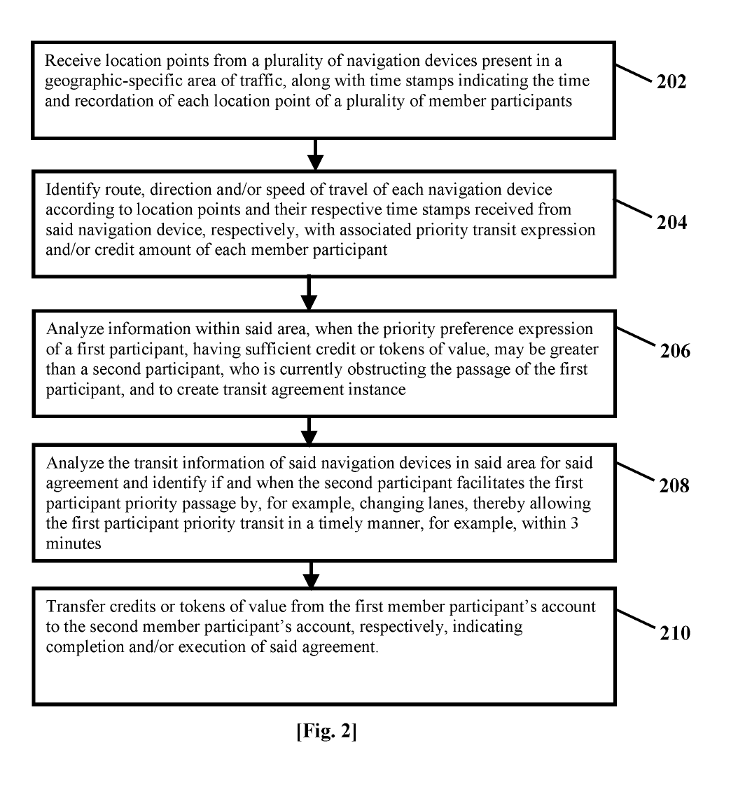

FIG. 2 is a flow chart illustrating a method for creation of an agreement, or recording a document as a contract at law, or Ricardian agreement, and linking it securely to other systems, such application servers and navigation devices, for the contract as an issuance of value and accounting according to some embodiments of the present invention; and

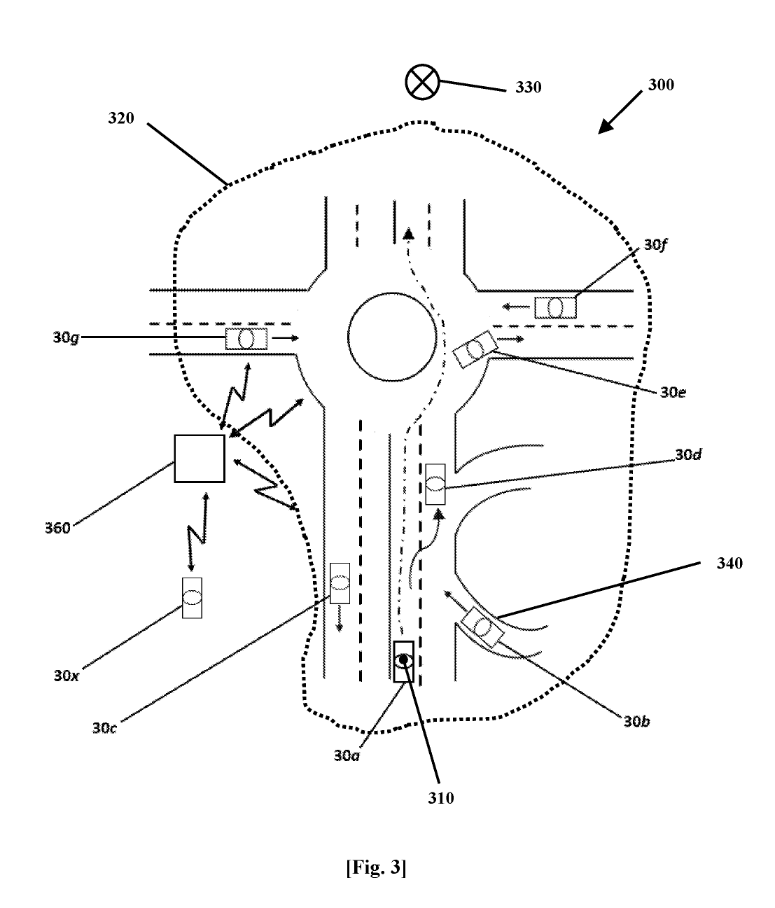

FIG. 3 is a schematic illustration of a roads system and system actors for mapping priority transit according to one embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Referring now to the invention shown in FIG. 1, which is a schematic illustration of a system 100 for creation of a priority transit mapping according to some embodiments of the present invention.

System 100 may include a plurality of navigation devices 110, each of the navigation devices may belong to a member of a priority transit mapping service which may be provided by system 100. Navigation devices 110 may include, for example, GPS devices, mobile phones, Personal Digital Assistants (PDA), Personal Navigation Devices (PND), car personal computer (PC), mobile computers, or any other suitable devices able to include, receive and manipulate and/or operate navigation software and/or devices which are capable of identifying their own location and time and either send it or store it and/or any sensor which may sense and record its location and time. The plurality of navigation devices 110 with connectivity capability may be in communication with application server 120, for example, by a cellular network or wireless network or any other mobile communication means. The connection between navigation devices 110 and application server 120 may be made by any known connection protocol, for example, Transmission Control Protocol (TCP), User Datagram Protocol (UDP), Hypertext Transfer Protocol (HTTP), Wireless Application Protocol (WAP) or any other suitable protocol.

Application server 120, having computer readable, non-transitory storage medium and computer programs and processors to execute instructions to interact with navigation device 110, for example, periodically, momentary locations of the member holding device 110. Application server 120 may collect and/or record time series of locations received from device 110 along with time stamps indicating the time at which each of the locations was recorded. In some embodiments, navigation device 110 may record momentary locations together with corresponding time stamps indicating the recordation times of these momentary locations. A momentary location may be recorded by navigation device 110, for example, in constant time intervals, for example, once in a second, and/or in constant travel distances, for example, every ten meters. Application server 120 may receive a time series of location points, along with the time stamps indicating the time at which each of the location points was recorded. Time series of location points may be received by application server 120 in constant time intervals as desired, for example, every three minutes.

Additionally, the members may send to application server 120, for example, by navigation devices 110, information on different events, for example, ‘degree of urgency’ priority alerts and/or ‘willingness to exchange credits or tokens of value for priority transit’ and/or ‘willingness to receive and/or defer to more urgent transit’ messages to other members.

Application server 120 may perform statistical analysis of the received time series of location points from plurality of navigation devices 110. Based on the statistical analysis, application server 120 may identify navigation patterns which may correspond to different priority transit characteristics which may facilitate creation of a priority transit agreement. Based on these patterns, application server 120 may create a dynamic priority transit agreement which may be updated, for example, whenever the statistical analysis shows a change in the navigation patterns demonstrating priority transit passing opportunities. The priority transit offer and/or agreement may be displayed, for example, on a display 112 of navigation device 110. Additionally, application server 120 may provide priority transit instructions, for example, based on the created priority transit mapping within a geographic-specific area. The instructions may be displayed, for example, on display 112. Additionally or alternatively, the instructions may be voiced by a speaker 114 which may be included in navigation device 110.

Application server 120 may deduce from the time series of location points received from navigation device 110, the momentary magnitudes and directions of velocities of the user holding navigation device 110. Application server 120 may perform analysis to identify navigation patterns and priority passing opportunities which may vary with different times in the day and/or days in the week.

By analyzing statistically the time series of location points received from plurality of navigation devices, application server 120 may identify, for example, road characteristics and/or priority travel or overtaking opportunities and/or points of interest such as, for example, approaching one-way roads, approaching two-way roads, approaching dead ends, approaching junctions of different types, allowable and unallowable overtaking conditions, approaching roundabouts, speed bumps, overpasses, underpasses, tunnels, number of lanes, speed limits, traffic lights, traffic signs, gas stations, parking lots, and other static and/or dynamic road characteristics and/or transit passing or overtaking points of interest. Application server 120 may create a priority transit mapping, for example, based on the identified static and/or dynamic road characteristics and/or priority transit and/or overtaking points of interest.

Additionally, application server 120 may perform statistical calculations to identify time-related characteristics such as, for example, traffic overtaking opportunities which apply for certain times of a day and/or days of a week, passing lanes which are allowable/unallowable in certain times of a day and/or days of a week, overtaking durations according to the time in a day and/or day in a week, traffic passing and overtaking conditions according to the time in a day and/or day in a week and other time-related characteristics.

From the time series of location points received from plurality of navigation devices 110, application server 120 may deduce routes, locations, directions of travel, and other parameters which may enable creation of anticipatory priority transit mappings and calculate the probability of upcoming priority transit opportunities, for example, in the next three minutes.

In some cases, there may be deviations between the navigation devices 110 and/or slight inaccuracies in the location points received from the different navigation devices 110. Application server 120 may perform statistical analysis in order to identify the most probable routes and priority transit situations. Application server 120 may create and/or update the priority transit mapping to include probable routes for priority transit in the immediate travel lanes.

Navigation device 110 may include, for example, a display 112, on which a navigational priority transit map, for example, created by application server 120, or navigation device 110, may be displayed. Additionally, messages, questions, and/or other information may be displayed on display 112. The messages, questions, and/or other information may be received from application server 120 and/or from other persons, autonomous machines, or a combination thereof, for example, human users or autonomous vehicle members of other navigation devices 110 or other suitable devices. Navigation device 110 may also include keyboard 116 and/or microphone 118, for example, to control navigation device 110 and/or for entering messages, alerts, and other information, for example, to send it to application server 120 and/or to other navigation devices 110 and/or any other suitable devices. Navigation device 110 may additionally include speaker 114, which may enable receiving voice messages and/or priority transit alerts.

Reference is now made to FIG. 2, which is a flow chart illustrating a method for creation of a priority transit mapping and agreements according to some embodiments of the present invention. As shown in block 202, the method may include, for example, receiving, for example, by application server 120, location points from a plurality of navigation devices 110 present in a geographic-specific area to be mapped, along with time stamps indicating the time of recordation of each of the location points. As shown in block 204, the method may include, for example, identifying, for example, by application server 120, route, direction and/or speed of travel of each navigation device 110 according to location points and their respective time stamps received from said navigation device, respectively, associate the relevant member and/or credits or tokens of value in the member's priority transit account. As shown in block 206, the method may include, for example, calculating priority transit opportunities, for example, by application server 120, most probable routes according to the received location points and their respective time stamps; and creating the priority transit agreement. As shown in block 208, the method may include, for example, analyzing, for example, by application server 120, transit information based on the navigation devices to determine if and when the yielding participant facilitates for the priority transit participant expedited passage by, for example, changing lanes, thereby allowing the priority participant passing or overtaking in a timely manner, for example, five minutes. As shown in block 210, the method may include, for example, transfer, for example, by application server 120, credits or tokens of value from the first priority transit member participant's account to the second yielding member participant's account, respectively, thus completing and/or executing said agreement.

Application server 120 may calculate the durations of passing or overtaking travel in certain portions of roads/intersections based on, for example, the received location points and their respective time stamps, and/or the speed that may be calculated therefrom.

Application server 120 may identify, for example, a probable bottleneck or one-way lane, if, for example, in a certain identified route, the statistical analysis shows pronouncedly that close to 100 percent of the navigation devices 110 report lack of passing or overtaking on substantially the same general direction of travel, for example, in over five minutes.

Application server 120 may identify, for example, a probable overtaking opportunity or preferred two-way road, if, for example, in a certain identified route, the statistical analysis shows pronouncedly that close to 100 percent of the navigation devices 110 report accelerated passing or overtaking on substantially the same general direction of travel, for example, in under one minute.

Additionally, application server 120 may identify different road characteristics such as, for example, traffic restrictions, special road features, traffic signs, traffic lights and/or various kinds of intersections that increase the probability of passing or overtaking conditions.

Application server 120 may perform a statistical analysis of the travel routes, for example, in an intersection. An intersection may be recognized by application server 120 if, for example, in a certain area, two or more routes intersect and/or draw near each other when coming towards certain area and then draw away from each other when going outwards of this area. Application server 120 may identify based on the statistical analysis different kinds of intersections and calculate different passing or overtaking opportunities, and suggest overtaking recommendations, based on the type of intersection, for example, T-intersection, roundabouts, intersections with overpass/underpass and/or intersections with certain turning limitations.

Application server 120 may perform additional steps when detecting varying passing or overtaking opportunities. Roundabouts, for example, detected by portions of routes which join to a closed loop and/or lack of location points in the center of an intersection and/or a route having substantially consistent direction diversion around a closed loop and/or by other methods, according to analysis of the location points and corresponding time stamps received from navigation devices 110, may negotiate agreements with multiple transit participant members, and create multi-participant agreements for simultaneous coordination whereby the preferred priority transit member overtakes several yielding transit participant members. Application server 120 may indicate the detected roundabout in the mapping and affirmative consensus, or lack thereof, among all associated members.

Some of navigation devices 110 can be motion sensitive, LIDAR, visual recognition, or radar enabled, and send movement signals to application server 120. Additionally or alternatively, motion sensors may be held proximately to at least some of the users by other means, and send movement signals to application server 120. Application server 120 may analyze the motion signals, optionally along with location, time and/or speed data, and identify road bumps, speed bumps, pedestrians, obstacles, and/or severe road conditions. For example, interferences in speed and/or movements signals which are similar in shape and/or which occur in substantially constant intervals or in other known standard intervals may be identified by application server 120 as speed bumps and, for example, indicate the speed bumps on the map. Interferences in speed and/or movement signals which are irregular, may be identified by application server 120 as occasional road bumps and/or severe road conditions. Application server 120 may indicate irregularities in the road such as, for example, the occasional road bumps and/or severe road conditions, on the map and, for example, indicate the severity of the irregularities, or the probability of obstacles, according to the frequency and/or strength of the received motion signals.

Application server 120 may receive inputs from other and/or additional sensors which may sense the roads and/or traffic. The sensors may be stationary and/or move independently from the users and/or included in navigation devices 110 and/or held proximately to at least some of the users by other means. The sensors may include, for example, image sensors, light sensors, motion sensors, sound sensors, or any other suitable sensors. In one exemplary embodiment of the present invention, overhead images and/or sensor input may be received and used by application server 120 to identify traffic and/or road conditions and/or patterns of traffic and/or road conditions. For example, but not limited to, transit authority pole camera, drone camera, and/or satellite camera images may be received and used by application server 120 to identify patterns of transit and/or passing or overtaking conditions. In another example, road department video camera live feeds may provide additional images to be received and analyzed by application server 120 to identify patterns of transit and/or passing or overtaking conditions.

Application server 120 may identify portions of roads in which the communication with navigation devices 110 is cut off and restored again after a certain distance. This may be detected by application server 120 as “disappearance” and “reappearance” of devices. Application server 120 may identify a pronounced consistent “disappearance” and “reappearance” of devices in substantially the same portion of the transit lane, thus deducing the existence of a tunnel in this portion of the lane. Application server 120 may mark the location of the identified tunnel on the navigation mapping, and modify, or limit, passing or overtaking agreements.

In some embodiments of the present invention, application server 120 may store data and/or patterns of member passing and overtaking behavior and history which, for example, in combination with data received in real time, such as, for example, location points received from navigation devices 110 along with time stamps, may facilitate identification of different passing or overtaking recommendations or agreement features.

Application server 120 may store for example, transit lane definitions, which may include, for example, lane width and/or vehicle axle limits. Application server 120 may identify the number of lanes in a transit path/road/highway by analyzing the dispersal area and/or density of the location points received from navigation devices 110 in, for example, a selected geographic-specific transit segment. Application server 120 may identify, at least approximately, the width of the dispersal area in a segment and deduce the number of lanes in the segment, for example, by dividing the width of the dispersal area by the lane width. Application server 120 may identify boundaries between the lanes by analyzing the distribution of the location points received from navigation devices 110. Application server 120 may indicate the number of lanes of road segments in the created navigation mapping and associate a passing or overtaking rating for that segment.

Some of the lanes in a transit path may have certain characteristics which may be identified by application server 120 and further analyzed. Application server 120 may identify, for example, by analysis of location points received from navigation devices 110 along with the respective time stamps, the direction of travel in each lane, and statistically measurable frequencies of passing and overtaking behavior indicating preferred lanes.

Other lanes may be assigned for certain vehicles, such as, for example, a lane for public transportation and/or a lane for high-occupancy vehicle, for example, two or more persons per vehicle. These assigned lanes may be characterized, for example, by being less loaded than other lanes and thus, for example, the speed of travel in those lanes may be higher. Application server 120 may identify these lanes, for example, by analysis of location points received from navigation devices 110 along with the respective time stamps, and use the lane for transitory priority passing or overtaking, as per local regulation/permissions.

Some other lanes may be assigned for right turns only or for left turns only. These lanes may be identified by application server 120, for example, by recognizing that pronouncedly all the users or close to 100 percent of the users traveling in a specific lane turn right in a respective intersection for right-turn only lanes and/or that pronouncedly all the users or close to 100 percent of the users traveling in a specific lane turn left in a respective intersection for left-turn only lanes, and, as per local regulation/permissions, and lack of having any transiting vehicles in the immediate area, may provide transitory priority passing or overtaking opportunity.

The specially assigned lanes may be assigned for only some hours of the day and/or days in the week. Application server 120 may recognize the hours in a day and/or days in a week in which these lanes have special characteristics, for example, by analyzing statistically, the location points, respective time stamps and/or direction or speed data which may be received, for example, from navigation devices 110 and/or calculated by application server 120. Application server 120 may mark the special lanes on the map according to the analysis. For example, these lanes may be marked as lanes with special characteristics only in the hours in a day and/or days in a week in which these lanes function as special lanes according to the statistical analysis, and, as per local regulation/permissions, and lack of having any transiting vehicles in the immediate area, may provide transitory priority passing or overtaking opportunity.

Application server 120 may recognize a stop sign, for example, by identifying that pronouncedly all the users or close to 100 percent of the users, for example, above 97 percent of the users, having speed of substantially zero at a certain point or certain small region of the road, usually, for example, within or close to an intersection area. In some cases, an intersection may include stop signs in more than one direction of the intersection, which may be recognized by application server 120. In some cases, application server 120 may recognize a stop sign in each direction of an intersection, for example, four directions, thus, for example, identifying the intersection as a four-way stop sign intersection type and marking it accordingly in the navigational mapping, and, as per local regulation/permissions, and lack of having any transiting vehicles in the immediate area, may provide transitory priority passing or overtaking opportunity.

Application server 120 may recognize a traffic light, for example, by identifying cycles including periods when pronouncedly all the users or close to 100 percent of the users, for example, above 97 percent of the users, having speed of substantially zero at a certain point or certain small region of the road, usually, for example, within or close to an intersection area. Application server 120 may calculate the cycle time of the traffic light. Additionally, application server 120 may recognize patterns of changes in the cycle times of a traffic light in different time in the day and/or days in the week. Application server 120 may mark the traffic light with the cycle time respectively to the time in the day and/or days in the week. Other statistical parameters may be calculated by application server 120, such as, for example, durations of red light and/or green light in each traffic light cycle, for example, respectively to the time in a day and/or day in a week and, for example, may be marked on the map respectively. Durations of red light may be recognized by application server 120 by identifying pronouncedly periods of substantially zero speed of users in the respective region. Durations of green light may be recognized by application server 120 by identifying pronouncedly periods of above zero speed of users in the respective region, and, as per local regulation/permissions, and lack of having any transiting vehicles in the immediate area, may provide transitory priority passing or overtaking opportunity.

In some intersections, a right turn may be permitted during periods of red light. Such intersection may be recognized by application server 120, for example, by identifying an intersection where there are periods of substantially zero speed for users who turn left or keep straight, while users who turn right pronouncedly have speed of above zero substantially incessantly. This may usually be combined with a right-turn only type of lane, which may be identified by application server 120, as described, and, as per local regulation/permissions, and lack of having any transiting vehicles in the right-turn only type of lane, may provide transitory priority passing or overtaking opportunity.

Application server 120 may calculate the time it may take to cross an intersection, for example, from each direction to each direction, for example, based on the analysis of the intersection parameters, including type of intersection, traffic lights, stop signs and other parameters described in detail above. Application server 120 may recognize the time it may take to cross an intersection, for example, for different hours in a day and/or days in a week, and, as per local regulation/permissions, and depending on volume of transiting vehicles in the immediate area, may provide transitory priority passing or overtaking opportunity.

Application server 120 may identify type and status of transportation infrastructure such as road closure arms at railroad crossings being up or down, and/or traffic signal status such as green or red, and/or the presence of vehicles at stop lights as sensed by in-road devices, by querying and/or receiving data from these devices individually if IoT enabled, or from a centralized data provider such as a department of transportation computer.

Application server 120 may identify facilities at sides of roads, such as, for example, gas stations and/or parking lots which may exist nearby a mall, restaurant, or any other facility. Application server 120 may identify the facilities at a specific geographic area when a substantial amount of user members' behavior deviates from an identified road, stops for a period of time and/or have a very slow velocity, and then returns to the road or to another identified road. The sufficient number of users deviating from the road in order to identify a facility may be predefined, determined, and/or stored in application server 120. The velocity of movement of the navigation device may be considered by application server 120 as a halt of the vehicle if the velocity is below a certain threshold which may be, for example, predefined, determined, and/or stored in application server 120. For example, if a person walks out of the car, takes navigation device 110 with him and advances by foot, the velocity of walking may be considered by application server 120 as a halt of the vehicle, and, as per local regulation/permissions, and depending on volume and kind of transit detected in the immediate area, may provide transitory priority passing or overtaking opportunity.

The previously mentioned road conditions, characteristics and facilities may be identified by application server 120 by receiving from navigation devices 110 location points along with corresponding time stamps and performing statistical analysis of the received location points along with corresponding time stamps. In some of the cases mentioned previously, calculation of speed and/or direction of navigation devices 110 may be required to identify the lane passing characteristic and/or overtaking facility. In some of the cases mentioned previously an analysis of the data according to the time in a day and/or day in a week may be required, for example, to provide information regarding characteristics of the lane, and passing opportunity, in the different time in a day and/or day in a week.

The previously-mentioned road conditions, characteristics and facilities may facilitate creation of passing or overtaking navigational mapping by application server 120, possibly along with other parameters which may be calculated by application server 120, for example, based on information received from navigation devices 110. In some of the cases mentioned previously, analysis by application server 120 may further base on other pre-stored and/or pre-acquired data and/or predetermined parameters and/or thresholds, and ‘passing enabled’ regulation within particular jurisdictions, at least some of them are mentioned previously.

Application server 120 may compare the identified characteristics calculated by application server 120 with pre-stored information, for example, in order to verify the accuracy of its identifications, or to analyze data in order to optimize and/or allow for recommendation for improving priority transit.

In some embodiments of the present invention, application server 120 may identify temporary and/or unusual events, for example, in real time, for example, based on information received from navigation devices 110, and indicate the temporary and/or unusual events on the created map. The temporary and/or unusual events may include, for example, traffic jams, road blocks, lane blocks, abnormal intersection activity and/or any other event which may deviate from the normal, for example, statistically calculated behavior of users identified by application server 120. Application server 120 may identify the temporary and/or unusual events by, for example, comparing the information received in real time to the statistically calculated normal characteristics and/or conditions of the roads, for example, characteristics and/or conditions of the roads which were previously calculated according to statistical analysis of the location points and time stamps received from navigation devices 110, as described in detail above, and analyze unusual or transitory conditions allowing for priority transit.

In some embodiments, for example, autonomous vehicle to human operated vehicle, application server 120 may ask for information from a client by, for example, sending a message, for example, by e-mail, SMS (Short Message Service) and/or by any other suitable method. The message may include a question which may be answered by the user by typing an answer, selecting an answer from several given options, speaking an answer, and/or by any other suitable method. Exemplary questions sent to a user may be “May I pass you before the upcoming traffic light?”, or “Is there a way you could change lanes, and move out of the way?” The user may be given the option to answer “yes” or “no”, for example, by typing the answer and/or by clicking the corresponding button and/or by any other suitable manner including, but not limited to, voice input.

In some embodiments, for example, autonomous vehicle to human operated vehicle, device for human operated vehicle may be pre-programmed to automatically accept requests and/or respond/reply to offers for priority within certain parameters, for example, offers meeting a certain credit or token of value threshold.

In some embodiments, for example, if an approaching vehicle is law enforcement with flashing lights indicating an emergency, application server 120 and/or receiving transit devices in member vehicles which are ahead of approaching law enforcement vehicle may be instructed to move aside, for example, to the shoulder and/or alternatively to slow or stop.

Application server 120 may suggest to a member user a preferred yielding route, for example, upon a request from the first member user to a second member user currently positioned as obstructing vehicle, application server 120 may suggest to the second member user a preferred yielding route, such as moving into the adjacent right lane, based on durations of traveling in certain roads and/or roads segments and/or intersections, which may be statistically calculated by application server 120 as described in detail previously.

Application server 120 may store and/or archive traveling routes of a member, for example, according to the member's request and/or permission. Application server 120 may analyze stored routes and, for example, identify based on the analysis of commonly traveled routes by the member the travel habits of the member. For example, application server 120 may identify that the member vehicle usually travels a given segment between 08:00 and 09:00 on Monday to Friday, and can provide historical vehicular transit and frequency of passing conditions. In another example, application server 120 may identify optimal times for that user and specific transit segment when traveling in the relevant time in a day and/or day in a week, application server 120 may present the identified commonly traveled route on a navigational mapping, for example, on display 112, and/or provide navigational instructions to the member based on the identified commonly traveled route.

Application server 120 may suggest, based on statistical analysis of previously offered prices and/or accepted prices and/or capacity and loading of the specific transport infrastructure, a price to offer that may likely be accepted by other members for priority transit.

Member, using keyboard or microphone or other suitable device, may request a destination and desired arrive time or time range and optionally desired amount to maximally offer, and application server 120 will determine mode of transport and/or route of transport and/or offers to make including price to offer, based on statistical analysis of previously offered prices and/or accepted prices and/or capacity and loading of the transport infrastructure.

Application server 120 may interface with member's calendars and/or schedules to suggest a transport and route and price to offer to arrive at the destination before the scheduled member event, thus relieving member of entering details to application server 120. In addition to interfacing with calendars and/or schedules, if desired by member, application server 120 may automatically contract for mode of travel and times of travel based on member's calendars and/or schedules and/or available funds.

Application server 120 may interface with data sources such as historical or forecasted traffic data, forecasted traffic-inducing events (such as schedules for sports or music events), historical or forecasted weather and/or meteorological data in order to optimize routes, times, and bid pricing.

Additionally, application server 120 may suggest alternative route(s), for example, in case of existence of a shorter and/or faster route to the required destination. For example, application server 120 may compare the traffic and/or road conditions in the commonly traveled route with real-time traffic information, and may suggest, for example, based on the comparison, alternative routes, for example, with better real-time priority transit and/or lane conditions. Additionally and/or alternatively, application server 120 may provide alerts on unusual transit and/or lane conditions. Application server 120 may provide the alerts by messages which may be displayed on display 112 and/or voiced by speaker 114 and or by other means, for example, e-mail, SMS, instant message (IM), machine to machine messaging (M2M), or any other suitable means.

Additionally, application server 120, based on historical congestion data and/or historical payment data and/or forecasted data, may suggest the vehicle depart earlier for the destination in order to opportunistically advertise and/or accept offers to move-aside or yield during anticipated high-probability congestion events.

Reference is now made to FIG. 3, which is a schematic illustration of a roads system and members 30a-30g and 30x of service for mapping priority transit according to one embodiment of the present invention. Roads system 300 is an exemplary road system and the present invention is not limited to road system 300 or any specific type of mobility, road, lane, queue, or transit path. Each member may transmit his/her/its location to an application server 360. Application server 360 may receive from the navigation device the location of the member, for example, periodically. For example, member 30a may be located at a specific time and place, 310, and may transmit location to application server 360. Application server 360 may record the location received from, for example, member 30a, along with a time stamp indicating the time at which the location of member 30a was recorded, and calculate a geographic-specific area of interest 320.

Member 30a may also send its destination 330 to application server 360, for example, which estimates a series of geographic-specific areas of interest 320. Alternatively, application server 360 may estimate a geographic-specific area of interest 320 of member 30a, taking into account, for example, the general direction, current road, historical tracks of member 30a and/or popular destinations and/or based on other suitable parameters, including probability of priority transit requests based on historical transit and/or current funds balance of credit or utility tokens of priority. Application server 360 may automatically define a group of members 30, for example, as those within geographic-specific area of interest 310, for example, which their momentary location may be relevant to on-going calculation of a route for member 30a from present location to given destination 330. For example, each of the members in members group 30 may advance in one of several possible routes which may present an obstruction to priority transit between location member 30a location 310 and destination 330. Member 30a may be defined as a user member 30a of group 30, which may be grouped according to requirements of member 30a, and/or destination 330. Additionally, members of group 30 may be selected by application server 360 according to, for example, the type of mobility of the member, for example, if the member travels by car, motorcycle, bicycle, foot, ship, air, and/or any other type of transportation. The members of group 30 may be selected, for example, to have similar type or class of transportation/mobility. Additionally, the members of group 30 may be selected, for example, according to their direction, e.g., in case a member of the service is located in a route between location of user member 30a and destination, but advances in the opposite direction, e.g., from destination to location 310, this member may not be included in group 30. Additionally or alternatively, the membership in a group may be limited to members in a certain distance from the momentary location of the user member 30a, or may be ranked by certain criteria, for example, members 30b-30g may present ‘Ongoing’, ‘Temporary’, for example within the upcoming estimated 30 seconds, or ‘No’ transit encumbrance for member 30a. In some embodiments, user member 30a may instruct application server 360 according to which parameters the members of group 30 may be selected, for example, the parameters mentioned previously and/or other parameters, such as, for example, the kind of road preferred for passing or overtaking by user member 30a, e.g., a broad road, a multi-lane road, a straight road, a highway with paved shoulder, slipway or sideway, emergency lane, bus lane, HOV lane, or any other path of travel. Additionally or alternatively, member 30a may specify a road, for example, a specific road number, or segment, which should be excluded from or included in the parameters calculating probable passing or overtaking route.

In some embodiments, application server 120 may rank member travelers, vehicles, or groups of travelers/vehicles, by their offering price, and/or collective tokens of value, for their yielding status, and/or preferential transit status.

Group of members 30 may change with time according to changes in situations of the members, changes in the traffic in which members take part, etc. A member may be added to a group, for example group 30, if his/her respective parameters meet the definitions of the group. A member may be removed from a group, for example group 30, if his/her respective parameters no longer meet the definitions of the group. For example, members may be added to the group 30 if, for example, an additional member enters a route, between the location 310 of member 30a and destination 330 and/or if a member, which was disconnected from application server 360 for some reason, re-connects to application server 360 at a certain later moment. For example, member 30b may enter a route, or having high probability of entering route, for example, greater than 90 percent, between location 310 and destination 330 from onramp road 340 within geographic-specific area of interest 320 and then, for example, it may be added to group 30. Members may be removed from group 30 if, for example, a member is transiting in an opposite, or, non-relevant direction, for example member 30c, or a member is no longer located, or has high probability of being located, for example, greater than 98 percent, in a route between the location 310 of member 30a and destination 330, for example, the member departs from the route, or, for example, exits from geographic-specific area of interest, or, for example, will be exiting from the geographic-specific area within a high probability of temporal tolerance, for example, greater than 99 percent within 10 seconds, or disconnects from application server 360 at a certain time. For example, member 30e may turn right, or deviate and then, for example, may not be located in a geographic-specific area of interest encumbering a route between location 310 and destination 330 and thus, for example, may be removed from group 30.

In another case, member 30a may broadcast priority transit request to arrive at a required destination 330 or issue a variable expression of a higher priority transit to all members in group 30 encumbering the route of priority member 30a, or, for example transit request to a specific encumbering member of group 30, for example, member 30d, to pass one of the members of group 30 and thus, for example, the yielding member 30d may take required action, for example, moving to the right-hand lane, so as not to be encumbering 30a priority transit. Member 30d may receive the priority request from 30a, or, for example, broadcast a non-priority vehicles status and/or set a ‘willingness to move’ indicator or variable expression of ability to yield or move ‘out of the way’, including, for example (optionally), a suggested price for yielding to the priority requestor. Application server 360 may have previously recorded, or dynamically receive, and/or poll, the non-priority vehicle status of member 30d, and perform statistical analysis to determine existence of a priority transit opportunity, with, for example, appropriate road conditions and/or overtaking agreement probability between member 30a mapping to, and/or matching, member 30d advancing in the same route and currently obstructing priority transit of member 30a based on said geographic-specific location and respective statistical transit times. Application server 360 may pre-determine priority characteristics of the immediately obstructing member 30d of the group and create a dynamic agreement, or Ricardian contract, for priority transit based on said location and respective time issued as the priority transit request agreement from the member 30a to the obstructing member 30d, and/or dynamically instantiate said agreement to incentivize obstructing member 30d to move to the right lane, yield, or otherwise give way, so as not to impede the transit of member 30a. After the yielding action is completed by member 30d, application server 360 may validate completion of said agreement, for example, but not limited to timestamped location data received from members 30a and 30d, or, for example, other autonomous or human sensory indicators, wherein upon priority passage being confirmed, and/or independently corroborated, and/or programmatically, or with human intervention, trigger an exchange of credit or token of utility between members 30a and 30d, whereby the account associated with priority member 30a is debited, and the account associated with yielding member 30d is credited, and/or electronically signed, and/or recorded. Member 30d being no longer located in an obstructing route to destination 330 between user member 30a and destination 330 may therefore be removed from group 30.

Application server 360 may receive the locations of the members of group 30, for example, periodically. Application server 360 may create a dynamic transit map showing the locations of the members of group 30 based on the received locations and the changes in group 30. Application server 360 may also calculate the movement of the members, for example, based on the changes in the locations between one update to the next one, for example, in case the locations updates are received periodically. Member 30a may receive from application server 360 the transit map, which may be displayed, for example, on a pre-loaded map on a display of, for example, the personal navigation device (shown in FIG. 1). The traffic map may dynamically change and show the location and movement of the members of group 30 and/or the changes in group 30. For autonomous vehicle level 1-3 members, visual display of each of the members of the service may be requested from application server 360 and their visual location be shown to other members. For autonomous vehicle level 4-5 members, visual display of each of the members of the service may, for example, not be required from application server 360 and their visual location may not need to be shown to other level 4-5 vehicle members.

Application server 360 may recalculate the preferred route, for example, periodically and/or upon request of user member 30a and/or upon change in the circumstances, for example, changes in traffic conditions, the disclosure of a new road accident which was not included in previous considerations, defective traffic signals, train schedules and/or inferred train approaches to on-grade train crossings which may pause member travel during a train crossing of the train intersection, or any other change in the conditions that may have an impact on the passing or overtaking considerations of member 30a regarding selecting a route to go to, for example, destination 330. Application server 360 may notify user member 30a on the updated preferred route for example, if the update in the preferred route is relevant to priority transit for member 30a, for example, periodically and/or upon change in the preferred route, priority transit status, or payment account threshold. Application server 360 may take into consideration, through statistical analysis, the current location of member 30a to determine whether the updated preferred route, priority transit status, or account threshold and priority transit conditions, are relevant to member 30a.

In the example of FIG. 3, member 30a may reach destination 330 through a junction or roundabout. Application server 360 may receive notifications and/or alerts on other transit vehicles or events. For example, application server 360 may receive a notification of transit priority for another vehicle member 30f In another example, application server 360 may receive a priority notice on a potentially blocked lane at the same junction or roundabout and may integrate the received information into the transit mapping and/or calculate based on the received information a preferred route among multiple vehicle members, 30f and simultaneously 30g, causing a transit ‘jam zone’ to reach destination 330.

Application server 360 may enable exchange of multiple messages between members of the service. A message sent by a member may be transmitted, at the choice of said members and/or of application server 360, to all the members of the service or to one or more groups of members which may be selected, for example, by the sending member and/or by application server 360, for example, according to the relevance of the information to the members, and/or the autonomous level among relevant members. Alternatively, a member may specify the members of the service to which the message should be sent, namely to each one or by groups or by any other relevant method of classification, depending on preferences and/or autonomous vehicle level. The messages may include, for example, transit information and/or priority alerts, such as, for example, vehicle class, for example police or emergency, lane conditions, velocity, vehicle capabilities, or special events along the route, for example, pedestrian identification, and/or any other kind of messages. The messages may be displayed on the display of the personal navigation device (shown in FIG. 1) or may be presented to the user on any other display, or audibly, or any other means of system-user interface, internet of things (IoT) sensor, or machine-to-machine, vehicle-to-vehicle, or mesh communications network between vehicles which may or may not require a display. Each of the members of the service, for example, each of members 30a, 30f and 30g may create a group agreement, for example, according to a beginning point, for example, a current location of the user member or other beginning point defined by the user member, and a required destination point, for example, defined by the user member. Additionally or alternatively, each of the users may define a group agreement of his own according to, for example, parameters mentioned previously and/or other suitable parameters. In FIG. 3, 30a has indicated the highest priority and is allowed priority transit, so application server 360 instantiates the group agreement, validates group performance/behaviors, and executes group payment settlement, for the relevant yielding transit members 30f and 30g.

Additionally, members of the service may choose specific members to construct a group, and/or ‘cluster’, from which members may receive information regarding their location and/or other transit information and/or other messages, and express interest in priority group travel, for example, a group of truck convoy vehicles, family members and/or friends and/or a commuting work team or any other chosen group of members, including a plurality of autonomous vehicle levels sharing a priority preference transit status.

### ALTERNATE EMBODIMENTS

In one embodiment, application server 120 functionality may be decentralized, rather than centralized, wherein each participating member acts as an independent intelligent node in a decentralized network. In one exemplary embodiment of the present invention, peer-to-peer and/or mesh networks may send and receive information which identify traffic and/or transit conditions and/or patterns of traffic and/or transit conditions to enable priority transit agreement, passing and overtaking, amongst each independent member, or group of members, in the network.

In one embodiment, a facility at a side of a road may be identified by application server 120 as a fuel station by a relatively short average duration of stay, for example, but not limited to, sufficient time to fill a fuel tank, charge/replace a battery, or other fuel storage and/or ‘top up’ device. The facility may also be identified by vehicle IoT status such as increase in onboard fuel level. The range of durations of stay suitable for a fuel station may be predefined, determined, and/or stored in application server. Additionally, application server 120 may identify the lane or lanes of the different fuel ports/nozzles, by identifying the specific routes of users for filling the fuel tank. The boundaries between lanes of the fuel ports/nozzles may be identified as discussed previously with reference to the lanes identification. Other facilities, for example, car washing machines, may be similarly discovered, tracked, and reserved. The queuing of vehicles at fuel stations and car washes may allow for priority refueling or priority washing agreements identified in similar manner to the methods described previously.

In one embodiment, an electric car ‘IoT charging station’ may offer and accept charging station reservations for a particular date and time. These offers may be manually contracted by or with a human operator or passenger(s) or other entities (such as family members or work group members), or may be automatically contracted by, for, and/or with an autonomous agent and/or vehicle.

In one embodiment, a service station (such as fueling, airplane wing de-icing) facility may offer and accept reservations for a particular date and time. These offers may be manually contracted by or with a human operator or passenger(s) or other entities (such as family members or work group members), or may be automatically contracted by, for, and/or with an autonomous agent and/or vehicle.

In one embodiment, parking lots near facilities, business locations, residential buildings, and any other parking lot may be identified by application server by recognizing many vehicles halting for a time above a predetermined or calculated time threshold and/or terminating their travel in the same area then remaining stationary for some period of time, which may be predefined or determined by application server 120. Queueing for parking and/or reserving priority parking spots, per local regulation/permissions, and depending on ‘smart’ parking infrastructure in the immediate area, may provide priority parking agreements identified in similar manner to the methods described previously. For example, private parking facilities may advertise, for example, available spots, times, lengths of stay, and price. As another example, public parking facilities, for example, parking spots on a street, may be obtained by encouraging an existing parked vehicle to vacate a spot through an inducement such as, for example, a monetary payment or token of value transfer and/or exchange.

In one embodiment, a member represented by autonomous bus and/or autonomous train may indicate this fact to application server 120. Application server 120 may use the information received from navigation devices 110 of bus/train vehicles to create a mapping of bus/train routes, and, as per local regulation/permissions, and depending on volume and kind of transit detected as well as lane mappings, may provide priority passing or overtaking segments of transit.

In one embodiment, a ‘smart city’ may contain ‘smart road’ networks with embedded IoT sensors, artificial intelligence augmented lanes, and other autonomous transit intelligence devices to facilitate communication of lane conditions, messaging, and transit preference priority with application server 120.

In one embodiment, a ‘flying car’ or vehicle may contain appropriate three-dimensional vector mobility and priority transit statistics and/or passing or overtaking opportunities and perform multi-level transit calculations and hierarchical priority transit similar to the methods and scenarios described previously, but without the restriction of a two dimensional, ‘flat’ transit lane, waterway, or passage.

In one embodiment, users or groups of users or organizations or governments may offer inducements to certain vehicle types (such as high polluting, low miles per gallon of fuel, wide loads, long lengths) to not travel during a certain timeframe and/or not travel in a particular geographic area. For example, during time periods and/or locations forecasted to have high air pollution, there may be offers of value and/or inducements to high-polluting vehicles to remain parked or otherwise avoid travel in a particular geographic area.

In one embodiment, wide load and/or long length transports (such as thirty-wheel truck tractor and trailer combinations, or other wide/long vehicles or heavy vehicles or restricted vehicles) may offer and optionally automatically contract for a travelling buffer zone of additional space around the transport.

While certain features of the invention have been illustrated and described herein, many modifications, substitutions, changes, and equivalents will now occur to those of ordinary skill in the art. It is, therefore, to be understood the appended claims are intended to cover all such variations, modifications, and/or changes as fall within the true spirit of the invention.

What is claimed is:

1. A system for incentivizing and expediting priority transit for a person, vehicle, or autonomous transit user, in route, the system utilizing computer programs, state, and non-transitory computer storage medium comprising:
an application server associated with a plurality of navigation devices, ascribed each to one of a plurality of members of a service, respectively, wherein the application server is configured:
to receive from said plurality of navigation devices time series of location points of each plurality of members of a geospatially definitive setting; and
to receive from a first member of the service a request to arrive at a required destination or variable expression of a priority broadcasted for transit; and
to receive from non-priority vehicles in the area a ‘willingness’ or variable expression of ability to yield or ‘move out of the way’; and
to receive data inputs from non-vehicles such as road monitors, road cameras, cellular telephone company data on and/or around transit areas, and/or transit signal states; and
to perform statistical analysis to determine existence of priority transit conditions for the first member of the service, or highest ‘paying’ member of the service, broadcasting priority transit routing, based on said momentary location information of said first member, where the server is to ascribe the member of the service to a particular transit group of related members who are advancing in the same route as said first member, wherein another second member, of said particular group is ahead of said first member requesting the priority transit, therein currently obstructing priority transit of the first member based on said location and respective time; and
to determine priority characteristics of the immediately obstructing second member of the group and create a dynamic agreement for priority transit based on said location and respective time issued as the priority transit request agreement from the first member to the second member of said service; and
to dynamically instantiate said agreement based on location and time definitions, wherein the second member is incentivized to move lanes, yield, or otherwise give way, so as not to impede the transit of the first member; and
to calculate completion of and execution of said agreement according to location data received from said first and second group members, and/or other vehicles and/or road monitoring and/or road cameras, wherein upon completion of preferential passage, an exchange of credit or token of value between members of the service is triggered.

2. The system according to claim 1, wherein said application server is configured:
to calculate said preferred priority transit route by considering a type of mobility associated with at least one of said members; and
wherein the type of mobility comprises an indication whether at least one of said members utilizes wheeled, non-wheeled, seafaring or airborne vehicles of transportation; and
wherein vehicle characteristics comprise an indication whether at least one of said members may be characterized by autonomous vehicle level 0-5; and
to calculate said dynamic priority transit agreement by considering said time-related road characteristic of said traffic sign and/or signal that applies at said certain time of day.

3. The system according to claim 1, wherein said application server is configured:
to create said agreement as a smart contract or a Ricardian contract recording a document as a contract at law, and linking it securely to other systems, such as accounting on a distributed ledger and/or blockchain, for the contract, and as an issuance or exchange of a credit or token of value.

4. The system according to claim 1, wherein said server is configured:
to receive from said member said required destination, wherein the server is to further provide to said member updated priority transit information which is inferred by the server based on actual information received by the server from other members in said transit group.

5. The system according to claim 1, wherein said server is configured:
to estimate said required destination of said member, wherein the server is to limit membership in said particular geographic-specific transit group to members that (a) advance in a same direction, and (b) are located within a certain distance from a momentary location of said member.

6. The system according to claim 1, wherein said server is configured:
to (a) choose said particular group of members from said plurality of members which share one or more group definitions and (b) to provide said preferred route to arrive at said destination, based on information received from members of said particular group, wherein the server is to change membership in said particular group according to a change in transit or priority preference status.

7. The system according to claim 1, wherein said server is configured:
to calculate said preferred route according to definitions of preferred route by said member, wherein the server is to remove a certain member from said geographic-specific group if said member deviates from a route so as to no longer encumber priority transit which ends at said required destination.

8. The system according to claim 1, wherein:
said preferred route is recalculated periodically by the server and takes into account a transit jam zone and/or priority transit impediment automatically determined by the server based on velocity of and/or autonomous signaling of group members in a particular geographic-specific zone.

9. The system according to claim 5, wherein:
at least one of said group definitions is defined by the member, wherein the server is to provide transit information, received from a first member of said particular transit group, to one or more other members of said particular transit group who chose to receive transit information updates from said first member, and/or jointly share a group priority status and/or account for priority transit credit or tokens of exchange.

10. The system according to claim 9, wherein:
said definitions defined by said member are from a list comprising a type of mobility of the member, autonomous level, direction of travel of the member, distance from said member, and kind of transit lane and/or vector of mobility being traveled by said member.

11. The system according to claim 5, wherein said application server is configured:
to periodically re-calculate which members are to be added to or be removed from said group of members.

12. The system according to claim 11, wherein said application server is configured:
to re-calculate said particular group of members according to at least one of a list comprising one or more changes in priority status and/or transit situations of said members, one or more changes in transit, one or more changes in characteristics of priority transit members, and one or more changes in definitions of said particular priority transit group.

13. The system according to claim 1, wherein said application server is configured:
to periodically receive updates on momentary location of each of said members.

14. The system according to claim 13, wherein said server is configured:
to calculate velocities of the members based on changes in locations of the members between one update to a next update, wherein the server can calculate priority transit opportunity, or completion of passing or overtaking agreements between one update and the next.

15. The system according to claim 1, wherein said application server is configured:
to provide periodic updates of said transit passing or overtaking data and/or opportunity.

16. The system according to claim 5, wherein said server is configured:
to (a) receive alerts and messages from at least one of said plurality of priority transit members and (b) calculate and provide said preferred priority transit route also based on said alerts and messages.

17. The system according to claim 1, wherein said application server is further configured:
to associate a member of the group as a human user utilizing a smart phone as a communications or navigation device in a transit vehicle for autonomous levels 0-3; and
to receive said time series of location points periodically and to record said time series of location points from said smart phone; and
to receive explicit agreement, from said human operator of said vehicle or pre-programmed automated acceptance, before issuance of said agreement for priority transit.

18. The system according to claim 1, wherein said application server is further configured:
to calculate the acceptance of, completion of, and execution of, said agreement, according to location data received from said members, and, in the event of heterogeneous autonomous member levels, utilizing both human and machine member inputs, trigger the acceptance, completion, and execution and exchange of said credit or token of value between respective members.

19. The system according to claim 1, wherein said application server is further configured:
to ‘advertise’ non-priority vehicle's willingness to move and an optional advertisement of ‘price’ or unit of token exchange required to move so as not to impede priority transit members.

20. The system according to claim 1, wherein said application server is further configured:
to interface to existing traffic light ‘smart’ infrastructure to enable dynamically setting an upcoming road intersection light to green for the priority transit vehicle when ‘smart’ transit route allows for said traffic light functionality, and when oncoming vehicles in other directions are configured to accept the priority transit agreement instantiated, or negotiated, and defer to said priority vehicle.

21. The system according to claim 1, wherein said application server:
is not centralized, but decentralized in a peer-to-peer or mesh network, wherein the logic required for the message transmission protocol of participating vehicles with their associated broadcast messages of respective transit priority, instantiation of contract agreement, transmitting physical state changes, validation of transit deferral, and exchange of credits or tokens of value for priority transit are dynamically calculated, negotiated, and resolved within a distributed network and/or distributed computing platform and/or distributed ledger without the need for said centralized ‘master’ server.

22. The system according to claim 1, wherein said application server is further configured:
according to traffic laws, for example, in the U.S. state of Colorado, Colorado Revised Statutes 42-4-705 “Operation of vehicle approached by emergency vehicle” (2017), to notify transiting vehicles of a vehicle with emergency lights activated, such that transiting vehicles are required to slow down and/or move aside, and/or to have the non-emergency vehicle accept and follow traffic laws for halting and/or passing an emergency event, for example, a vehicle with activated emergency lights.

23. A method of providing a priority transit management and exchange service, including computer programs encoded on non-transitory computer storage media, the method comprising:
receiving information on momentary location of each of plurality of members of said service; and
providing a transit passing or overtaking probability matching based on said locations; and
providing to a member of the service a preferred passing or overtaking route to arrive at a required destination, based on said momentary location information of said members; and
ascribing a member of the service to a particular group of members who are advancing in a similar route as said member, wherein a majority of other members of said particular group are ahead of said member and/or are encumbering priority transit; and
instantiating a priority transit agreement, or Ricardian contract, between said matching members, wherein a plurality of autonomous vehicles, and/or human operators, can record a document as a contract at law, and link it securely to other systems, such as an accounting system comprising balances for said members; and
validating and executing said priority transit agreement, transferring of credit or a token of utility from one priority vehicle member gaining priority transit from another yielding vehicle member, thereby, wherein the method is to be performed by a server comprising at least a hardware component.

24. The method according to claim 23, further comprising:
calculating said preferred route by taking into account a type of mobility and vehicle characteristics associated with at least one of said members, wherein the type of mobility comprises an indication whether at least one of said members utilizes wheeled, non-wheeled, seafaring or airborne vehicles of transportation, and wherein vehicle characteristics comprises an indication whether at least one of said members utilizes autonomous vehicle level 0-5.

25. The method according to claim 23, further comprising:
receiving from said member said required destination, and providing to said member updated transit information containing passing or overtaking opportunities which are inferred based on actual information received from other members in said particular group.

26. The method according to claim 23, further comprising:
estimating said passing or overtaking opportunities for said member; and
limiting membership in said particular group to members that (a) advance in a similar direction, and (b) are located within a certain distance, and/or expected transit time or destination arrival time, from a momentary location of said member.

27. The method according to claim 23, further comprising:
choosing said particular group of members from said plurality of members which share one or more same group definitions; and
providing said preferred priority transit route based on information received from members of said particular group; and
changing membership in said particular group according to a change in transit behavior.

28. The method according to claim 23, comprising:
calculating said preferred priority transit route according to definitions of preferred route given by said member; and
removing a certain member from said particular group if said certain member deviates from a route which inhibits priority transit to said required destination.

29. The method of claim 23, further comprising:
recalculating said priority transit route periodically by taking into account a transit ‘jam zone’ automatically determined based on velocity of group vehicle members in particular zone or transit area of interest.

30. The method according to claim 23, wherein said group definitions are from a list comprising momentary locations relevant to a route to said destination, type of mobility of the member, direction of travel of the member and distance, and/or transit time away from said member, wherein the method further comprises:
receiving a priority transit-related message from said member; and
receiving from said member an indication that the transit-related message is to be shared with other members; and
determining which members are to receive said priority transit-related message based on relevance of information in said priority transit-related message to said members; and
sending the priority transit-related message to said members based on the relevance of the information utilizing centralized and/or mesh and/or peer-to-peer communications networking.

31. The method of claim 23, wherein:
at least one of said group definitions is defined by said member, wherein the method comprises providing priority transit-related information, received from a first member of said particular group, to one or more other members of said particular group configured to receive priority transit-related information updates from said first member and/or said first member with a particular group attribute such as enrollment in a particular ride-sharing network.

32. The method according to claim 23, wherein said configuration comprises:
‘clustering’ said particular priority transit grouping, as in a vehicle convoy, according to specification of the human or autonomous vehicle user members to be included, as specified by said member.

33. The method according to claim 32, further comprising:
re-calculating said particular priority transit group of members according to at least one of a criterion list comprising one or more changes in situations of said members, one or more changes in transit, one or more changes in characteristics of priority status, one or more changes in characteristics of priority member credit or token of value account balance, and one or more changes in definitions of said particular group.

34. The method according to claim 23, further comprising:
receiving updates on momentary location of each of said members periodically.

35. The method according to claim 34, further comprising:
calculating velocities of the members based on changes in locations of the members between one update to a next update.

36. The method according to claim 23, further comprising:
providing updates of said priority transit-related data periodically.

37. The method according to claim 27, further comprising:
receiving passing or overtaking alerts and/or messages from at least one of said plurality of members, matching passing or overtaking opportunities, instantiating an agreement for priority transit between said members, receiving acceptance of agreement, providing said preferred priority transit route validation also based on said alerts and/or messages, and executing said agreement and triggering member accounting settlement.

38. The systems, methods, steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, systems, methods, operations, or processes described.

39. Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.
